(19) United States
(12) Patent Application Publication
(10) Pub. No.: US 2026/0370633 A1
(43) Pub. Date: Nov. 19, 2026

(54) METHODS AND SYSTEMS FOR SECURE DATA TRANSFER BETWEEN COMPUTING DEVICES

(71) Applicant: North River Labs, LLC, Tuckahoe, NY (US)

(72) Inventors: James Thor WILLIAMS, Tuckahoe, NY (US); Oliver Thomas Norman CHRISTIE, Diana, TX (US)

(73) Assignee: North River Labs, LLC, Tuckahoe, NY (US)

(21) Appl. No.: 19/647,526

(22) Filed: Apr. 14, 2026

Related U.S. Application Data
(60) Provisional application No. 63/804,838, filed on May 13, 2025.

(51) Int. Cl. H04L 9/40

(52) U.S. Cl. CPC H04L 63/0428

(57) ABSTRACT

A method of securely transferring data between a first computing device and a second computing device is provided. The method comprises sensing one or more first physical parameters associated with the first computing device using a first physical sensor on the first computing device and generating a first device identifier based on the one or more first physical parameters. The method further comprises sensing one or more second physical parameters associated with the second computing device using a second physical sensor on the second computing device; generating a second device identifier based on the one or more second physical parameters; and allowing the transfer of data between the first computing device and the second computing device if the first device identifier corresponds to a known first device identifier and the second device identifier corresponds to a known second device identifier.

### CROSS-REFERENCE TO RELATED APPLICATIONS

This application claims the benefit of U.S. Provisional Patent Application No. 63/804,838, filed May 13, 2025, the entire contents of which are incorporated herein by reference.

### FIELD

The present disclosure relates generally to secure data transfer and specifically to computing device authentication based on physical device parameters.

### BACKGROUND

Enabling secure data transfers between computing devices continues to be an ongoing issue. Known techniques for authenticating computing devices to enable device-to-device data transfer may include cryptographic keys, static device identifiers, and hardware-based security mechanisms. However, these known techniques may become compromised.

For example, cryptographic keys may be used to authenticate the identities of two computing devices by facilitating a key exchange process to verify each device before establishing communication. For example, two devices may be pre-configured with a shared key, with one device encrypting a challenge message using the key, and the other device decrypting and verifying the response. If the decrypted response matches the expected value and the authentication is confirmed, secure communication may be enabled. However, data security may be compromised if credentials are stolen or intercepted. For example, if an attacker obtains the pre-shared key, it can be used to impersonate a legitimate device and gain unauthorized access.

Static device identifiers such as MAC addresses, serial numbers, and/or authentication tokens may additionally or alternatively be used for device authentication. However, static identifiers can be readily extracted from compromised devices and/or spoofed by unauthorized devices. Additionally, these identifiers do not account for changes in device behavior, operational state, or environmental conditions, making it difficult to detect unauthorized access attempts from otherwise approved devices that may have been compromised.

In addition, device authentication according to known techniques may be based on device behavior over time. Patterns in device network activity, data transfer frequency, and/or operational behavior may be analyzed to detect discrepancies. For example, a device with an approved identifier connected to an unusual network or accessing data in an atypical manner may be flagged as a potential security risk. Unlike static credentials, behavioral authentication may detect compromised or unauthorized devices, however this technique may involve continuous monitoring of device activity and/or frequent recalibration of acceptable deviations in device behavior.

### SUMMARY

Disclosed herein are methods and systems for securely transferring data between computing devices. Disclosed methods may involve sensing one or more physical parameters associated with each computing device, generating device identifiers based on the one or more physical parameters, and determining whether the generated device identifiers correspond to known identifiers before allowing the transfer of data between the computing devices. These device identifiers may form Physically Unclonable Functions (PUF) serving as unique, hardware-intrinsic signatures of a particular computing device. Physical parameters may include operational characteristics (e.g., voltage profiles, clock drift, processor load) or environmental factors (e.g., ambient temperature, magnetic field signatures, acoustic noise profile), and may be detected using a physical sensor of a computing device. Device identifiers may additionally or alternatively be generated based on device parameters of the computing device. For example, device parameters may include initial power-up timestamps, device serial numbers, and/or network identifiers.

Generated device identifiers may then be transmitted for authentication using a handshake-based authentication process and/or a third-party authentication process. In handshake-based authentication, a first computing device and a second computing device may exchange device identifiers and compare the received device identifiers to stored known identifiers to determine whether received device identifiers correspond sufficiently to known device identifiers. In third-party authentication, generated device identifiers may be transmitted to a centralized authentication system that may verify the identifiers of both computing devices before allowing data exchange, ensuring that neither computing device accesses the device identifiers of the other computing device.

To generate device identifiers, a transformation function may be used to process sensed physical parameters and/or device parameters into a structured output. This transformation function may apply cryptographic hashing, feature extraction, and/or statistical encoding techniques to standardize raw physical parameter measurements and/or device parameters. Such standardization may ensure that device identifiers remain consistent across authentication attempts while preserving identifier uniqueness.

Once generated, these device identifiers may be stored in a database on the computing device that generated them and/or added to a database of known credentials located on another computing device and/or on the authentication system. Databases on the computing devices and/or authentication system may themselves be encrypted to further enhance data security. To enable authentication, generated device identifiers may be compared against a stored set of known device identifiers using a similarity score metric, allowing the system to verify authenticity while accounting for naturally occurring variations in physical parameter measurements. This may ensure that minor deviations in physical parameter measurements do not prevent successful authentication of a legitimate device while preventing unauthorized access by unapproved devices. This approach may improve data security by reducing reliance on pre-shared cryptographic keys and/or static device identifiers, which may be vulnerable to theft and/or spoofing, while enabling repeatable and device-specific authentication based on intrinsic hardware variations and/or environmental characteristics.

In some embodiments, a method of securely transferring data between a first computing device and a second computing device is provided, the method comprising: sensing one or more first physical parameters associated with the first computing device using a first physical sensor on the first computing device; generating a first device identifier based on the one or more first physical parameters; sensing one or more second physical parameters associated with the second computing device using a second physical sensor on the second computing device; generating a second device identifier based on the one or more second physical parameters; and allowing the transfer of data between the first computing device and the second computing device if the first device identifier corresponds to a known first device identifier and the second device identifier corresponds to a known second device identifier.

In some embodiments, the one or more first physical parameters and the one or more second physical parameters each comprise at least one parameter selected from a group consisting of: a sensor acceleration profile, a sensor orientation profile, a magnetic field signature, a temperature measurement, an acoustic noise profile, a voltage profile, a current profile, a clock drift profile, geographical positioning data, a processor load signature, an ambient pressure measurement, an ambient humidity measurement, and an ambient light measurement. In some embodiments, generating the first device identifier and the second device identifier comprises: applying a first transformation function to encode the one or more first physical parameters to form the first device identifier; and applying a second transformation function to encode the one or more second physical parameters to form the second device identifier. In some embodiments, the first transformation function and the second transformation function each comprise a cryptographic hashing function configured to generate a device identifier based on the respective one or more physical parameters. In some embodiments, the first transformation function and the second transformation function are each configured to generate a device identifier based on variations in the respective one or more physical parameters. In some embodiments, the method further comprises: aggregating a plurality of values corresponding to the respective one or more physical parameters to generate one or more composite values; and applying the respective transformation function to encode the generated one or more composite values to form a device identifier. In some embodiments, the method further comprises: generating the first device identifier is based on the one or more first physical parameters and one or more first device parameters associated with the first computing device; and generating the second device identifier is based on the one or more second physical parameters and one or more second device parameters associated with the second computing device. In some embodiments, the one or more first device parameters and the one or more second device parameters each comprise at least one parameter selected from a group consisting of: an initial power-up timestamp, a device serial number, and a network identifier. In some embodiments, generating the first device identifier and the second device identifier comprises: applying a first transformation function to encode the one or more first physical parameters and the one or more first device parameters to form the first device identifier; and applying a second transformation function to encode the one or more second physical parameters and the one or more second device parameters to form the second device identifier. In some embodiments, the first transformation function and the second transformation function each comprise a cryptographic hashing function configured to generate a device identifier based on the respective one or more physical parameters and the respective one or more device parameters. In some embodiments, the method further comprises: aggregating a plurality of values corresponding to the respective one or more physical parameters and the respective one or more device parameters to generate one or more composite values; and applying the respective transformation function to encode the generated one or more composite values to form a device identifier. In some embodiments, the method comprises: transmitting the first device identifier to the second computing device; determining, at the second computing device, if the first device identifier corresponds to the known first device identifier; transmitting the second device identifier to the first computing device; and determining, at the first computing device, if the second device identifier corresponds to the known second device identifier. In some embodiments, the method comprises, prior to transmitting the first device identifier to the second computing device, transmitting from the second computing device to the first computing device a request for the first device identifier. In some embodiments, the method comprises, prior to transmitting the second device identifier to the first computing device, transmitting from the first computing device to the second computing device a request for the second device identifier. In some embodiments, the method comprises: transmitting, to an authentication system, the first device identifier and the second device identifier; and determining, at the authentication system, if the first device identifier corresponds to the known first device identifier and the second device identifier corresponds to the known second device identifier. In some embodiments, the method comprises, prior to transmitting, to an authentication system, the first device identifier and the second device identifier: transmitting, to the authentication system, a request for a data transfer involving the first computing device and the second computing device, wherein the request is transmitted from the first computing device, the second computing device, or both computing devices. In some embodiments, the method comprises, prior to transmitting, to an authentication system, the first device identifier and the second device identifier: transmitting, from the authentication system, a request for a data transfer involving the first computing device and the second computing device, wherein the request is transmitted to the first computing device, the second computing device, or both computing devices. In some embodiments, the method comprises sensing one or more third physical parameters associated with the authentication system using a third physical sensor on the authentication system; generating a third device identifier based on the one or more third physical parameters; allowing the transfer, between the first computing device and the authentication system and between the second computing device and the authentication system, of respective device identifiers if the first device identifier corresponds to the known first device identifier, the second device identifier corresponds to the known second device identifier, and the third device identifier corresponds to a known third device identifier. In some embodiments, the method comprises: storing, on the first computing device, one or more device identifiers generated based on the one or more first physical parameters; transmitting one of the one or more stored device identifiers generated based on the one or more first physical parameters to the second computing device, the authentication system, or both; storing, on the second computing device, one or more device identifiers generated based on the one or more second physical parameters; and transmitting one of the one or more stored device identifiers generated based on the one or more second physical parameters to the first computing device, the authentication system, or both. In some embodiments, the method comprises storing, on at least one of the first computing device, the second computing device, or the authentication system, one or more parameters, wherein the one or more parameters comprise at least one parameter selected from a group comprising: the first device identifier; the second device identifier; one or more timestamps corresponding to the transmission of the first device identifier, the transmission of the second device identifier, or both; and an indication of whether data transfer was allowed between the first computing device and the second computing device. In some embodiments, the method comprises storing, on at least one of the first computing device, the second computing device, or the authentication system, one or more known device identifiers for comparison to the first device identifier, the second device identifier, or both. In some embodiments, the method comprises: transmitting, to at least one of the second computing device or the authentication system, an updated first device identifier after a first predetermined time period; and transmitting to at least one of the first computing device or the authentication system an updated second device identifier after a second predetermined time period, wherein the updated first device identifier and the updated second device identifier are based, respectively, on updated one or more first physical parameters and updated one or more second physical parameters. In some embodiments, the first predetermined time period, the second predetermined time period, or both, are determined based on a time at which the first device identifier was transmitted, a time at which the second device identifier was transmitted, or both. In some embodiments, the known first device identifier and the known second device identifier each correspond to a device authorized to participate in data transfer. In some embodiments, the method comprises computing a first similarity score and a second similarity score based respectively on a plurality of device identifiers associated with the first computing device and the second computing device to determine if the first device identifier corresponds to the known first device identifier and the second device identifier corresponds to the known second device identifier. In some embodiments, the method comprises restricting data transfer between the first computing device and the second computing device if the first device identifier does not correspond to a known first device identifier or the second device identifier does not correspond to a known second device identifier.

In some embodiments, a system for securely transferring data between a first computing device and a second computing device is provided, the system comprising one or more processors and memory storing instructions that, when executed by the one or more processors, cause the system to: sense one or more first physical parameters associated with the first computing device using a first physical sensor on the first computing device; generate a first device identifier based on the one or more first physical parameters; sense one or more second physical parameters associated with the second computing device using a second physical sensor on the second computing device; generate a second device identifier based on the one or more second physical parameters; and allow the transfer of data between the first computing device and the second computing device if the first device identifier corresponds to a known first device identifier and the second device identifier corresponds to a known second device identifier.

In some embodiments, a non-transitory computer readable storage medium storing instructions for securely transferring data between a first computing device and a second computing device is provided, wherein the instructions, when executed by one or more processors of an electronic device, cause the device to: sense one or more first physical parameters associated with the first computing device using a first physical sensor on the first computing device; generate a first device identifier based on the one or more first physical parameters; sense one or more second physical parameters associated with the second computing device using a second physical sensor on the second computing device; generate a second device identifier based on the one or more second physical parameters; and allow the transfer of data between the first computing device and the second computing device if the first device identifier corresponds to a known first device identifier and the second device identifier corresponds to a known second device identifier.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1A depicts an exemplary system for secure data transmission between two computing devices, according to some embodiments.

FIG. 1B depicts an exemplary system for secure data transmission between two computing devices including an authentication system, according to some embodiments.

FIG. 2 depicts an exemplary sensing module for secure data transmission between two computing devices, according to some embodiments.

FIG. 3A depicts an exemplary process for secure data transmission between two computing devices, according to some embodiments.

FIG. 3B depicts an exemplary process for generating device identifiers for secure data transmission between two computing devices, according to some embodiments.

FIG. 4 depicts an exemplary computing system, according to some embodiments.

### DETAILED DESCRIPTION

Disclosed herein are methods and systems that provide a secure, device-specific authentication framework for device-to-device data transfers, leveraging measured physical parameters to generate unique device identifiers. An exemplary process may begin with a computing device sensing one or more physical parameters using onboard or external sensor modules. These physical parameters may include sensor acceleration and/or angle, magnetic field variations, voltage fluctuations, clock drift, processor load, temperature readings, and/or other environmental factors, and may serve as unique signatures for each computing device. Additionally, system-level device parameters, such as initial power-up timestamps, device serial numbers, and/or network identifiers may be used to provide persistent attributes that supplement measured physical parameters. These physical parameters and/or device parameters may then be used to generate a device identifier. To generate a device identifier that may be repeatable yet resistant to direct duplication, physical parameters and/or device parameters may be processed using, for example, a transformation function that may involve cryptographic hashing, statistical encoding, and/or feature extraction techniques.

Generated device identifiers may then be transmitted for authentication via a handshake-based authentication process and/or a third-party authentication process. In handshake-based authentication, a first computing device and a second computing device may exchange device identifiers and determine whether received device identifiers correspond to stored known identifiers. In third-party authentication, an authentication system may verify both computing devices'identifiers before allowing data exchange. To determine whether received device identifiers correspond known identifiers, a similarity score may be computed based on, for example, one or more distance metrics. If computed distance between a received and known device identifier is within a predefined threshold, authentication may be approved. Use of similarity score-based authentication may thus ensure that minor variations in sensor-derived values, for example due to environmental changes, do not lead to authentication failures. If device identifiers of both computing devices are found to correspond to a known device identifier, the authentication may be approved and secure data transfer between the computing devices enabled. However, if one or both of the device identifiers are found to not correspond to a known device identifier, the authentication may be rejected and data transfer and/or communication between the computing devices may be restricted.

Disclosed methods and systems may provide an authentication approach with enhanced security and adaptability compared to known techniques including cryptographic keys and static identifiers. Unlike pre-shared cryptographic keys which can be reused if compromised, or static identifiers such as MAC addresses which can be spoofed, disclosed device identifiers may be derived from measurements of a computing device's unique physical parameters. Use of measured physical parameters, that may include device-specific variations, as the basis for device identifiers may increase the difficulty of generating an identical identifier without direct access to the computing device's sensor data. Thus, use of device-specific identifiers may increase the difficulty for unauthorized actors to bypass authentication through conventional credential theft or impersonation. Additionally, by optionally deriving device identifiers from a combination of measured physical parameters and static device parameters such as serial numbers and/or initial power-up timestamps, an exemplary system may enhance authentication consistency while maintaining device identifier uniqueness.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

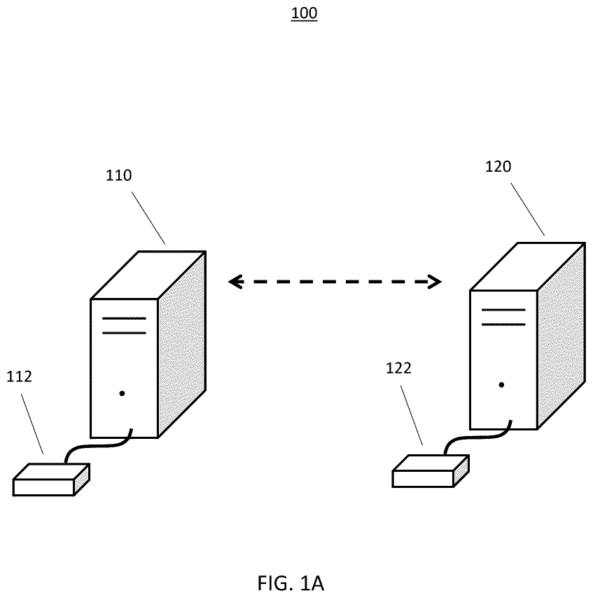

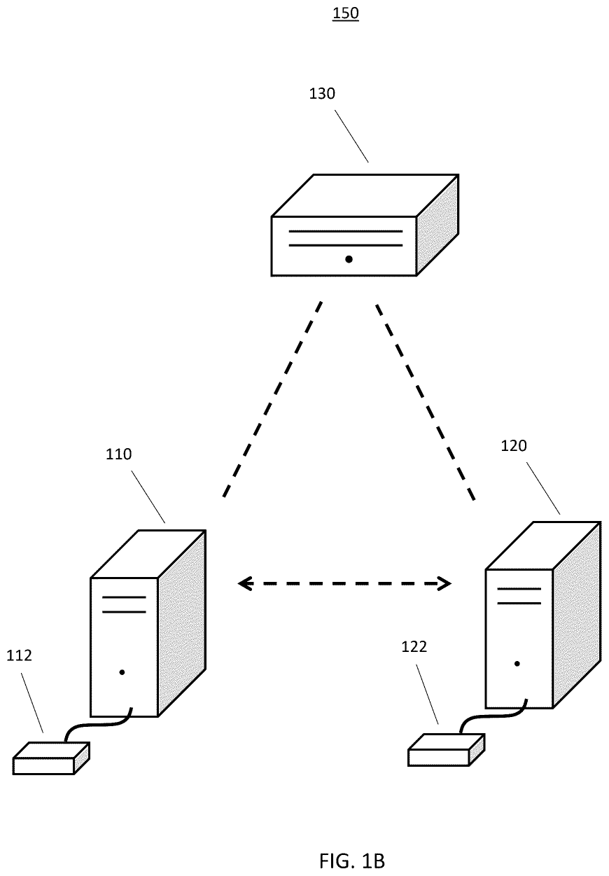

FIG. 1A depicts a system 100 for authenticating computing devices based on device-specific identifiers derived from parameters of the computing devices detected by physical sensors. System 100 may include a first computing device 110 equipped with and communicatively coupled to first sensing module 112, and a second computing device 120 equipped with and communicatively coupled to second sensing module 122. First computing device 110 and second computing device 120 may include, for example, a personal computer, a laptop, a tablet, a smartphone, an embedded computing system, a network router, a server, and/or an Internet of Things device. Each computing device may include one or more processors, memory components, and/or communication interfaces, for example wired and/or wireless network interfaces.

In some implementations, first sensing module 112 and second sensing module 122 may include one or more physical sensors or sensor arrays that may be integrated within and/or attached to first computing device 110 and second computing device 120 respectively. For example, first sensing module 112 and second sensing module 122 may include one or more on-board sensor components within first computing device 110 and second computing device 120 respectively. For example, first sensing module 112 and second sensing module 122 may form a part of the chipset, power management circuit, and/or other integrated hardware of first computing device 110 and second computing device 120 respectively.

In some implementations, first sensing module 112 and second sensing module may be external to first computing device 110 and second computing device 120 respectively. For example, physical sensor devices housed in an external sensing module may be designed to be detachable and/or swappable, providing flexibility in monitoring different physical parameters based on system requirements. In other implementations, first sensing module 112 and second sensing module 122 may include one or more separate peripheral sensors.

First sensing module 112 and/or second sensing module 122 may be communicatively coupled to a computing device via a wired interface. For example, a sensing module may be communicatively coupled to a computing device via a USB connection, an SPI bus, a PCIe interface, and/or an Ethernet interface. An exemplary wired interface may take the form of a USB-C and/or a USB-A interface. An exemplary wired interface may facilitate high-speed data transmission, low-latency communication, and/or power delivery between first computing device 110 and second computing device 120 and first sensing module 112 and second sensing module 122 respectively.

Additionally or alternatively, first sensing module 112 and second sensing module 122 may be communicatively coupled to first computing device 110 and second computing device 120 respectively via a wireless interface based on, for example, Bluetooth, Wi-Fi, NFC, an ultra-wideband connection, an RFID link, and/or a cellular network connection including, for example, LTE and/or 5G. Use of a wireless interface may enable remote and/or flexible placement of first sensing module 112 and second sensing module 122, reduce constraints associated with wired interfaces, and/or allow authentication of distributed and/or mobile computing devices.

First sensing module 112 and second sensing module 122 may be configured to detect one or more physical parameters associated with first computing device 110 and second computing device 120, respectively. Physical parameters may be detected using components such as temperature sensors, voltage sensors, current sensors, attitude sensors, magnetometers, accelerometers, gyroscopes, and/or frequency measurement circuits. These physical parameters may include operational characteristics such as power consumption patterns, clock drift, and/or processor load, as well as environmental characteristics such as temperature, magnetic field signatures, and/or ambient pressure.

In addition to physical parameters, first sensing module 112 and second sensing module 122 may be configured to detect one or more device parameters. Device parameters may include system attributes intrinsic to the operation and/or configuration of each computing device. For example, device parameters may include an initial power-up timestamp, a device serial number, a network identifier, a firmware version, and/or a cryptographic key stored in secure memory. Unlike physical parameters, which may vary based on environmental conditions and device operational states, device parameters may remain relatively stable and provide persistent attributes that can contribute to authentication and device identification.

FIG. 1A depicts a handshake-based authentication method in which first computing device 110 authenticates second computing device 120, and second computing device 120 authenticates first computing device 110 before a transfer of data is allowed. As described in further detail below, such an approach may involve each computing device independently generating at least one device identifier based on one or more sensed physical parameters using its respective sensing module, for example first sensing module 112 and second sensing module 122, and/or based on one or more device parameters. First computing device 110 may transmit its at least one generated device identifier to second computing device 120, which may compare it to a stored set of known device identifiers (e.g., device identifiers corresponding to devices authorized to participate in data transfer) to determine whether the at least one received device identifier corresponds to at least one device identifier of the stored set of known device identifiers.

Likewise, second computing device 120 may transmit at least one of its own device identifiers to first computing device 110 for authentication in a reciprocal manner. If a first device identifier originating from first computing device 110 and a second device identifier originating from second computing device 120 both correspond to at least one device identifier of the stored set of known device identifiers, secure data transfer between the computing devices may be permitted.

First computing device 110 and second computing device 120 may maintain continuous power to store and retrieve device identifiers, with power supplied by the computing device motherboard, an external source, and/or an integrated or remote battery. The computing device registry may store at least eight unique device identifiers with the ability to scale based on user-specified limits constrained by hardware and software capabilities. The registry may reside within first sensing module 112 and second sensing module 122 or may be embedded within first computing device 110 and second computing device 120. In this way, stored identifiers may be retrieved via physical access to the computing devices.

First computing device 110 and second computing device 120, and/or first sensing module 112 and second sensing module 122 may include software that can store, access, and/or compare device identifiers, with this software secured against modification by external systems or networks. Additionally, first computing device 110 and second computing device 120, and/or first sensing module 112 and second sensing module 122 may incorporate software-based verification mechanisms, allowing authentication by a trusted external system, for example the authentication system discussed below, while restricting modifications or unauthorized access.

FIG. 1B depicts a system 150 for third-party computing device authentication. For example, system 150 may include an authentication system 130 that may act as an intermediary to verify the identities of first computing device 110 and/or second computing device 120, which may include first sensing module 112 and/or second sensing module 122 respectively. In some implementations, authentication system 130 may be a dedicated authentication server hosted on a local network or in a cloud-based infrastructure, managing a secure database of known device identifiers. In other implementations, authentication system 130 may be a router or onboard processor, providing localized authentication services for connected devices. Authentication system 130 may be communicatively coupled to first computing device 110 and/or second computing device 120, and may communicate with said computing devices via wired or wireless protocols, such as Ethernet, Wi-Fi, Bluetooth, NFC, and/or cellular networks.

In some implementations, first computing device 110 and/or second computing device 120 may transmit at least one generated device identifier to authentication system 130. These transmissions may be additional to or alternative to a handshake-based authentication approach involving exchange of device identifiers between computing devices.

Authentication system 130 may compare, for each of first computing device 110 and/or second computing device 120, the at least one received device identifier against a stored set of known device identifiers to determine whether the at least one received device identifier corresponds to at least one device identifier of the stored set. If a first device identifier originating from first computing device 110 and a second device identifier originating from second computing device 120 both correspond to at least one device identifier of the stored set of known device identifiers, authentication system 130 may grant approval for data to be transferred between the computing devices. Authentication system 130 may be implemented as a server, cloud-based authentication service, and/or dedicated authentication device. Authentication system 130 may store historical authentication data, apply additional security policies, and/or revoke access for devices flagged as compromised and/or unauthorized.

In addition to first computing device 110 and/or second computing device 120, authentication system 130 may be communicatively coupled to one or more other computing devices, acting as an intermediary to verify the identities of these one or more other computing devices in the same way as authentication system 130 verifies the identities of first computing device 110 and/or second computing device 120 as described above. For example, first computing device 110, second computing device 120, and/or the one or more other computing devices may be connected to a local network. In this way, the authentication process described below may apply not only to first computing device 110 and/or second computing device 120, but to one or more other computing devices connected to a network, for example all other computing devices connected to a network. As additionally described below, the connection between authentication system 130 and computing devices may itself be authenticated, and authentication system 130 may include a dedicated sensing module to generate one or more physical parameters that may form the basis of generated device identifiers associated with authentication system 130. Generated device identifiers associated with authentication system 130 may additionally or alternatively be based on one or more device parameters as described below.

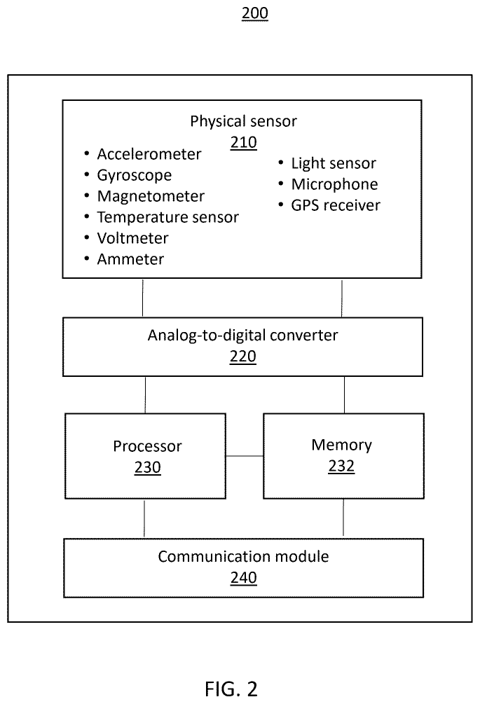

FIG. 2 depicts an exemplary sensing module 200 of a computing device, for example first sensing module 112 and/or second sensing module 122 as described in the context of FIGS. 1A and 1B. Sensing module 200 may be communicatively coupled to and/or integrated into a corresponding computing device. As discussed above, sensing module 200 may be communicatively coupled to a corresponding computing device via a wired and/or wireless connection. Additionally or alternatively, sensing module 200 may form surface-mounted components and/or integrated circuit packages within an exemplary computing device's hardware architecture. Sensing module 200 may be used to generate one or more physical parameters and/or one or more device parameters. As described above, physical parameters and/or device parameters may form the basis for generating at least one device identifier used to verify the identity of the computing device thereby enabling secure data transmission.

Sensing module 200 may include a physical sensor or sensor array 210, which may in turn include one or more sensing devices. These sensing devices may detect physical parameters of a computing device, for example various operational and/or environmental characteristics, including device motion, orientation, ambient conditions, and/or electrical properties. For example, sensing devices making up physical sensor 210 may include an accelerometer, a gyroscope, a magnetometer, a temperature sensor, a voltmeter, an ammeter, a light sensor, a microphone, and/or a GPS receiver. Signals collected by the sensing devices may be in analog form, requiring further processing before use in authentication operations.

To convert analog signals collected by the sensing devices into digital signals, sensing module 200 may include an analog-to-digital converter 220. Analog-to-digital converter 220 may ensure that analog readings captured by physical sensor 210 can be processed, stored, and/or transmitted digitally to a corresponding computing device to which sensing module 200 is coupled. Such analog-to-digital conversion may be important in generating device identifiers, as digitized outputs may provide a standardized representation of the detected physical parameters and/or enable signal processing techniques such as filtration and normalization.

Digitized sensor data may be processed by processor 230, which may be the processor of a corresponding computing device to which sensing module 200 is coupled, an embedded microcontroller, or a dedicated processing unit incorporated into sensing module 200. Processor 230 may be configured to execute firmware or embedded software routines that manage sensor operations, including data acquisition, preprocessing, and/or transmission to the corresponding computing device. Processor 230 may control the polling interval of one or more of the sensing devices, apply sensor filtration to reduce noise, and/or perform sensor calibration.

Processor 230 may additionally generate at least one device identifier based on one or more detected physical parameters and/or one or more device parameters. For example, as discussed below, processor 230 may apply a transformation function, which may include encoding operations, statistical analysis, and/or cryptographic hashing, to generate a unique and repeatable device identifier. Memory 232 may store device identifiers, sensed physical parameters, device parameters, calibration data, transformation function outputs, and/or raw sensor data for later processing or authentication verification. Additionally, memory 232 may be used to maintain historical authentication records, store threshold values for similarity-based authentication, and/or retain firmware updates related to sensing module 200 operations.

Communication module 240 may enable wired or wireless transmission of physical parameters, device parameters, and/or generated device identifiers to the computing device to which communication module 240 is coupled, to another computing device, and/or to an authentication system. Communication module 240 may support USB, SPI, PCIe, Ethernet, Bluetooth, Wi-Fi, NFC, and/or cellular communication protocols, allowing local and/or remote verification of device identity. In a handshake-based authentication process, communication module 240 may facilitate direct exchange of device identifiers between two computing devices, while in a third-party authentication process, communication module 240 may transmit identifiers to an authentication system for verification.

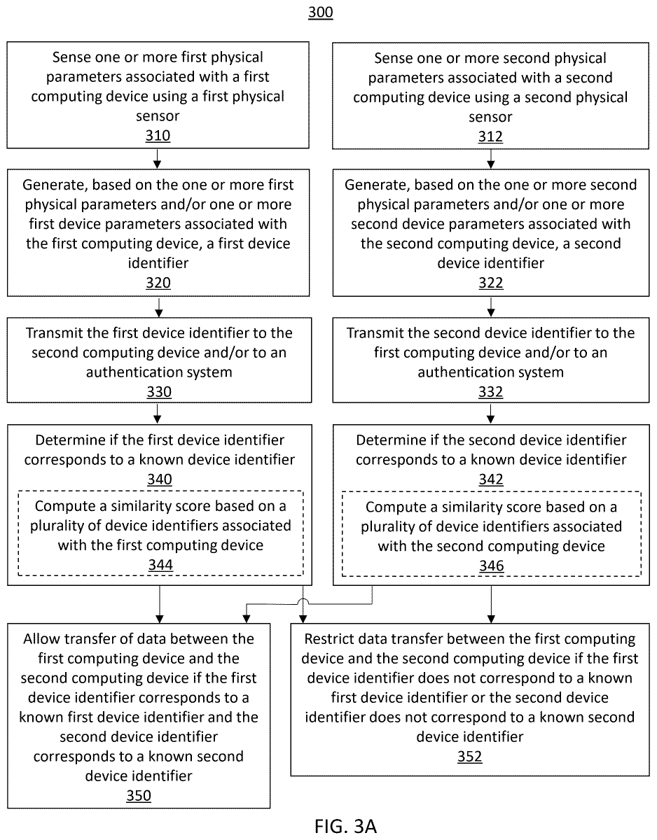

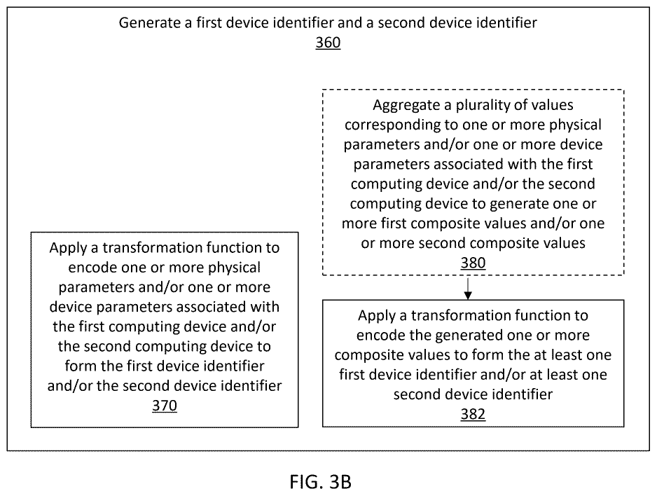

FIG. 3A depicts a process 300 for secure data transmission between two computing devices, leveraging device identifiers generated from physical parameters associated with each computing device. Process 300 may be executed on a first computing device, a second computing device, and optionally on an authentication system depending on whether a device-to-device authentication (handshake authentication) process or a third-party authentication process is followed, as described in context of FIGS. 1A and 1B.

Process 300 may begin with detection of physical parameters for each computing device. At step 310, a first sensing module, such as first sensing module 112, may detect one or more first physical parameters associated with the first computing device, such as first computing device 110. At corresponding step 312, a second sensing module, such as second sensing module 122, detects one or more second physical parameters associated with the second computing device, such as second computing device 120. Detection of physical parameters for each computing device may occur at a scheduled time, periodically, and/or immediately prior to a data transfer request.

Physical parameters of the first computing device and/or second computing device measured by physical sensors may include sensor acceleration profile, sensor orientation profile, magnetic field signature, temperature measurement, acoustic noise profile, voltage profile, current profile, clock drift profile, geographical positioning data, processor load signature, power consumption profile, and/or processor load profile. Physical parameters may additionally or alternatively include measurements of ambient characteristics such as temperature, pressure, humidity, light, and/or magnetic field strength. To capture these parameters, each physical sensor may include one or more sensing devices such as accelerometers, gyroscopes, magnetometers, temperature sensors, voltmeters, and/or ammeters as discussed above.

At step 320, the first computing device may generate a first device identifier based on the one or more first physical parameters and/or one or more first device parameters. Similarly, at step 322, the second computing device may generate a second device identifier based on the one or more second physical parameters and/or one or more device parameters. Device parameters used to generate device identifiers may include system-level attributes such as a device serial number, an initial power-up timestamp, a cryptographic key, and/or a network identifier. These device parameters may provide persistent device identity characteristics that supplement hardware-dependent measurements of physical parameters. This supplementation may in turn enhance authentication security by ensuring that device verification is based on both stable system attributes and dynamic sensor data, improving resistance to spoofing.

FIG. 3B depicts a process 360 by which a first device identifier and a second device identifier are generated. At step 370, a transformation function may be applied to encode one or more physical parameters and/or device parameters into a device identifier. This transformation function may involve cryptographic hashing, feature extraction, statistical encoding, and/or normalization techniques. As discussed below, the transformation function may additionally apply rounding, averaging, and/or similarity-preserving hashing to reduce the likelihood that slight variations in underlying physical parameters result in identifiers different enough to cause an authentication failure.

In some implementations, the transformation function may include a cryptographic hashing function or another secure hash algorithm, to generate a device identifier from one or more physical parameters and/or one or more device parameters. Cryptographic hashing may create a repeatable device identifier based on physical and/or device parameter that is difficult to forge. In some implementations, a similarity-preserving hashing function may be used instead, allowing device identifiers generated from slightly varying physical parameter values to remain comparable while preserving identifier uniqueness. To accomplish this, a similarity-preserving hashing function may involve encoding values such that small differences in input parameters produce hash outputs that remain similar to one another. To form a device identifier using a hash function, physical and/or device parameters may be preprocessed by filtering and/or adjusting to reduce noise and/or correct errors.

Next, preprocessed data may be converted into a consistent structured format before being passed through a hash function such as SHA-256. Forming this structured format may involve concatenating multiple sensor readings and/or device parameters into a single data string, encoding values in a fixed-length representation. For example, if a sensor collects physical parameters including a voltage reading of “3.3 V” and a temperature of “27.7 C,” and a device parameter including serial number “1G3ST54,” these values may first be rounded and/or adjusted for consistency before being concatenated to form data string “3.30002771G3ST54.” In some embodiments, only the physical parameters may be used to form the data string (e.g., “3.3000277”). The number of parameters used to form the data string may be modulated to balance security with processing time, increasing the number of parameters to increase uniqueness of the string or decreasing the number of parameters to reduce processing time.

Such structured data strings may then be byte-encoded, ensuring that each is compatible with the hash function before being processed through the function to generate a fixed-length hashed device identifier. In the case of a SHA-256 hash function, the device identifier may take the form of a 256-bit alphanumeric string. Because hashing is repeatable, the same parameter input may produce the same identifier output, allowing computing devices to be reliably identified and authenticated. Additionally, because the hash is one-way, the parameter input may not readily be derived from the identifier output, improving security.

Alternatively, the transformation function may apply feature extraction techniques to analyze and encode specific characteristics of or patterns in sensed physical parameters before generating the device identifier. Feature extraction may involve selecting stable, repeatable attributes in physical parameter data, such as frequency domain features or characteristic patterns in, for example, fluctuations in ambient temperature. For instance, if a temperature sensor records small periodic variations in ambient temperature due to device operation cycles or environmental changes, the transformation function may identify the recurring pattern rather than using a single temperature reading as an input. For example, the mean temperature, maximum-to-minimum variation, time frequency, and/or temperature profile slope may be identified and used as the physical parameter input in place of raw data. These extracted characteristic or pattern-based inputs may then be refined using data compression or encoding methods to ensure that unique and/or consistent aspects are used to generate the identifier, improving resistance to transient noise. The device identifier may then be generated using a hash function to output an alphanumeric string as described above or using a binary encoding to output a fixed-length bit sequence.

In some implementations, the transformation function may be configured to generate a device identifier based on variations in one or more physical parameters. Similar to feature extraction discussed above, this approach may involve tracking dynamic changes in sensed physical parameter values over time rather than using isolated readings. For example, a transformation function may analyze changes in processor load patterns, voltage fluctuations, and/or clock drift over repeated measurements, encoding these variations into a unique but repeatable device identifier. This method may increase security as evolving variations in physical parameter values may be difficult to predict and/or replicate for unauthorized access.

For example, a computing device's power consumption may exhibit minor repeating variations due to changes in processor activity, battery usage, and/or power fluctuations. A transformation function may capture the average voltage trend, peak-to-peak variation, and/or frequency of fluctuations over time. If a computing device's voltage measurements across multiple readings show a recurring oscillation between 3.25 V and 3.30 V with a frequency of 60 Hz, for example, the transformation function may encode this pattern into the device identifier. This may ensure that even if an attacker attempts to spoof a device by providing a device identifier based on a fixed voltage value, the lack of expected variation may cause the device authentication attempt to fail. As described above, the device identifier may be generated using a hash function to output an alphanumeric string or using a binary encoding to output a fixed-length bit sequence.

Statistical encoding and/or normalization techniques may also be used in the transformation function to reduce noise and/or to improve consistency. Statistical encoding may involve averaging sensor readings, correcting errors, and/or adjusting data to allow small variations. Normalization techniques may adjust raw physical parameter values to fit a standardized range or distribution, improving device identifier stability despite fluctuations in individual physical parameter values due to, for example, environmental changes or sensor drift.

In some implementations, rather than directly transforming raw sensor values into a device identifier, an exemplary system may first aggregate multiple raw physical parameter values and/or device parameters before applying a transformation function. At step 380, a plurality of values corresponding to one or more physical parameters and/or one or more device parameters may be aggregated to generate one or more first composite values for the first computing device and/or one or more second composite values for the second computing device. This aggregation may involve averaging, weighting, and/or concatenating combinations of sensor values, allowing the device identifier to be derived from a broader data set rather than a single isolated measurement, in turn reducing sensitivity to transient noise or fluctuations in physical parameter values.

Following aggregation, at step 382, an exemplary system may apply a transformation function to encode the composite values into the first device identifier and/or second device identifier. This encoding may ensure that the device identifier is not only unique to each computing device but also structured in a standardized manner for efficient processing. As described above, this transformation function may involve cryptographic hashing, feature extraction, statistical encoding, and/or normalization techniques.

As depicted in FIG. 3A, once device identifiers are generated, the generated device identifiers may be transmitted for authentication. At step 330, the first computing device may transmit its first device identifier either directly to the second computing device or to an authentication system. Similarly, at step 332, the second computing device may transmit its second device identifier to the first computing device and/or to the authentication system. If device-to-device authentication (e.g., handshake authentication) is used, each computing device may receive and verify the device identifier from the other. If third-party authentication is used, one or both computing devices may send their device identifiers to the authentication system. In both cases, as described below, transmitted device identifiers may be compared to device identifiers of a stored database of known device identifiers. For example, the first computing device, the second computing device, and/or the authentication system may be connected to a local area network and known device identifiers may be stored in a registry accessible by computing devices connected to the network. Depending on the configuration of the sensing modules, transmission at steps 330 and 332 may occur via wired interfaces such as USB, PCIe, and/or Ethernet, and/or wireless interfaces such as Wi-Fi, Bluetooth, NFC, and/or cellular networks.

To establish a connection between the authentication system and the first computing device and/or the second computing device, the authentication system, the first computing device, and/or the second computing device may sense one or more physical parameters as described above in the context of steps 310 and 312, generate device identifiers based on one or more physical parameters and/or device parameters as described above in the context of steps 320 and 322, and exchange device identifiers as described above in the context of steps 330 and 332. For example, one or more third physical parameters associated with the authentication system may be detected using a third physical sensor on the authentication system. These one or more third physical parameters and/or one or more third device parameters may be used to generate a third device identifier in the manner described above with respect to first and second physical parameters, first and second physical sensors and/or sensor modules, first and second device parameters, and first and second device identifiers. A third device identifier may thus be used to authenticate a transfer of data and/or device identifiers between the first computing device and the authentication system, and the second computing device and the authentication system. For example, a transfer of data and/or device identifiers between the first computing device and the authentication system, and the second computing device and the authentication system may be allowed if the first device identifier corresponds to the known first device identifier, the second device identifier corresponds to the known second device identifier, and/or the third device identifier corresponds to a known third device identifier. This process may effectively represent device-to-device authentication between the authentication system and the first computing device and/or the authentication system and the second computing device.

During an initial authentication or registration process, the first and/or second computing device may receive and store the device identifiers of the authentication system, allowing the respective computing device to recognize and verify the authentication system when initiating data transfers or receiving instructions. Before a new computing device is added to a network, for example, device identifiers of the authentication system may be pre-loaded into the memory of the new computing device, ensuring that the new computing device can verify the authentication system when attempting to join the network. These stored device identifier values may be exchangeable, allowing for replacement of compromised device identifiers while maintaining secure authentication.

Additionally, the authentication system may facilitate authentication of new computing devices within the network, enabling the new computing devices to securely transfer data to pre-existing computing devices. For example, the authentication system may transmit device identifiers of pre-existing computing devices to the memory of a newly added computing device, enabling it to authenticate with the pre-existing computing devices. Additionally, the authentication system may be provided with device identifiers of the new computing device, after which it may initiate an authentication sequence with the new computing device, requesting a device identifier for comparison with those initially provided. This step may ensure that newly added computing devices are verified before being granted access to network resources, reducing the risk of unauthorized access, spoofing, and/or impersonation attempts.

At step 340, an exemplary system may determine if the first device identifier corresponds to a known first device identifier, while at step 342, the system may determine if the second device identifier corresponds to a known second device identifier. This determination may involve comparing the respective received device identifier to a securely stored set of known device identifiers to verify the received identifier. For example, this set of known device identifiers may be pre-installed on the first computing device, the second computing device, and/or the authentication system during device provisioning. This set of known device identifiers may be updated periodically based on previously authenticated sessions, system administrator approvals, and/or automated enrollment processes. In device-to-device authentication, determination of whether the first device identifier corresponds to a known first device identifier may occur at and may be made by the second computing device, while determination of whether the second device identifier corresponds to a known second device identifier may occur at and may be made by the first computing device. In third-party authentication, determination of whether the first device identifier corresponds to a known first device identifier and/or the second device identifier corresponds to a known second device identifier may both occur at and may be made by the authentication system.

Determination of whether the first device identifier corresponds to a known first device identifier at step 340 and whether the second device identifier corresponds to a known second device identifier at step 344 may be completed within a predefined time interval, for example within 0.5 seconds. By completing authentication within the predefined time interval, an exemplary system may prevent timeout-related failures that could disrupt secure data exchange.

In some implementations, the first computing device, the second computing device, and/or the authentication system may store known device identifiers representing authorized computing devices in a database. In some implementations, the first computing device, the second computing device, and/or the authentication system may store, in addition to known device identifiers, historical device identifiers associated with successful and/or unsuccessful authentication attempts. Such an expanded set of stored device identifiers may allow an exemplary system to recognize previously verified computing devices and/or detect unauthorized access attempts. The first computing device, the second computing device, and/or the authentication system may additionally or alternatively maintain a registry of authorized computing devices within a network, specifying which computing devices are permitted to communicate and transfer data, while restricting all other computing devices from unauthorized access. The first computing device, the second computing device, and/or the authentication system may additionally or alternatively maintain a history of all data exchanged between computing devices on a network, enabling the detection of instances in which data was exchanged without successful authentication of a computing device. As mentioned below, if such unauthorized data transfer is detected, an exemplary system may isolate and/or restrict communication between the unauthorized computing device and other computing devices on the network.

Following the generation of new device identifiers for each computing device, the generated device identifiers may be preloaded and/or added into the above-described database of the first computing device, the second computing device, the authentication system, and/or all computing devices on a local network. Upon receipt of a request to verify another computing device and/or an authentication system based on a provided device identifier, a computing device and/or an authentication system may determine whether the newly provided device identifier corresponds sufficiently with the set of stored known device identifiers. This stored set of known device identifiers may be stored based on device from which the device identifiers were received, enabling efficient comparison of newly received device identifiers. For example, newly received device identifiers may be compared to all other stored known device identifiers, or for more efficiently processing, may be compared to known device identifiers from the device providing the new device identifier.

In addition to a computing device storing known device identifiers of other computing devices, the computing device may store internally generated device identifiers, i.e. device identifiers generated by a sensor module communicatively coupled to and/or on-board the computing device itself. For example, a computing device may store its own previously generated device identifiers in a database within local memory, for example on the computing device and/or on a sensing module communicatively coupled to the computing device.

Databases storing known device identifiers on a computing device and/or on the authentication system, and/or databases storing a computing device's own device identifiers, may be stored in a secure memory location. For example, a database storing known device identifiers and/or a database storing a computing device's own device identifiers, may be stored in the memory of the computing device and/or the authentication system, and/or in a sensor module communicatively coupled to the computing device. To ensure secure storage, aforementioned databases themselves may be secured using encryption and/or hashing techniques designed to protect stored data from unauthorized retrieval and/or tampering, thereby preventing illicit access to device identifiers stored on a computing device and/or on the authentication system.

In some implementations, physical parameters and/or device parameters may be measured and/or determined, and device identifiers generated, upon receiving an authentication request from another computing device and/or from an authentication system. Additionally or alternatively, physical parameters and/or device parameters may be measured and/or determined, and device identifiers generated, upon a computing device generating a request to authenticate a data transfer between the computing device and another computing device and/or authentication system. Additionally or alternatively, physical parameters and/or device parameters may be updated, and device identifiers generated, at a predetermined or dynamically determined frequency. These updated device identifiers may be stored in a database on the computing device generating the device identifiers and/or on a database of known device identifiers on the authentication system. For example, physical and/or device parameters may be measured and/or determined, and device identifiers may be generated, periodically, such as at least every 30 minutes, at least every hour, at least every 3 hours, at least every 6 hours, at least every 12 hours, at least every 18 hours, at least every day, at least every 2 days, at least every 3 days, at least every week, at least every 2 weeks, at least every 3 weeks, at least every month, at least every 2 months, at least every 3 months, at least every 6 months, at most every 6 months, at most every 3 months, at most every 2 months, at most every month, at most every 3 weeks, at most every 2 weeks, at most every week, at most every 3 days, at most every 2 days, at most every day, at most every 18 hours, at most every 12 hours, at most every 6 hours, at most every 3 hours, at most every hour, and/or at most every 30 minutes. In this way, physical parameters and/or device parameters may be updated, and device identifiers generated, based on the time at which the most recent device identifier was generated.

Additionally or alternatively, physical and/or device parameters may be measured and/or determined, and device identifiers may be generated in response to one or more detected events including a computing device powering on or restarting, a change in network connectivity, a detected security anomaly, an attempt to access restricted data, a scheduled system check, a firmware and/or software update, and/or a request from an external system or administrator for reauthentication. Once generated, one or more device identifiers may be stored in a database on the sensor module and/or computing device that generated the device identifiers and/or transmitted to another computing device and/or the authentication system for storage in a known identifier database as described above. In this way, in response to a request for a device identifier, instead of measuring and/or determining new physical parameters and/or device parameters, and generating a new device identifier, a computing device may transmit one of the one or more stored device identifiers.

In this way, databases storing known device identifiers on a computing device and/or on the authentication system, and/or databases storing a computing device's own device identifiers, may be updated. For example, databases storing known device identifiers on a computing device and/or on the authentication system, and/or databases storing a computing device's own device identifiers, may be updated in response to system policy changes, software and/or firmware updates, and/or security events. For example, an exemplary system may execute tasks to add to a database of known device identifiers those device identifiers associated with trusted computing devices and/or revoke device identifiers associated with compromised computing devices. Periodic updates to device identifier databases may ensure that an exemplary system accounts for changes in or updates to sensed physical parameters. For example, as described above, an authentication system may implement scheduled device identifier refresh cycles, wherein a first computing device transmits an updated first device identifier to the second computing device and/or authentication system after a predefined time period, and a second computing device similarly transmits an updated second device identifier. For example, if values corresponding to the physical parameters of a computing device (e.g., temperature, voltage stability, and/or clock drift) gradually change over time, for example due to aging hardware, environmental changes, and/or system reconfigurations, updating device identifiers may ensure authentication remains accurate while allowing for minor evolutions in parameter values.

Thus, updated device identifiers corresponding to the first computing system, the second computing system, and/or the authentication system may be based on updated one or more physical parameters and/or device parameters measured on and/or corresponding to corresponding to the first computing system, the second computing system, and/or the authentication system. An exemplary system may compare updated device identifier values to prior updates to identify unexpected deviations, based on comparison to historical patterns, that may indicate a tampering or spoofing attempt. For example, if deviations in updated device identifiers exceed a predefined threshold, an exemplary system may flag the device for further review, prompting manual inspection or additional authentication challenges before allowing further data exchange.

Authentication requests, which may include a request for data transfer, may be initiated by the first computing device, the second computing device, and/or the authentication system. For example, a first computing device may request that the second computing device authenticate itself, and may include a device identifier from the first computing device with the request. In response to the authentication request, the second computing device may then measure and/or determine physical and/or device parameters to generate a new device identifier, and/or may retrieve a stored device identifier, before transmitting the new and/or stored device identifier. If the request did not include a device identifier from the first computing device, the second computing device may transmit a request for a device identifier from the first computing device. One or both computing devices may then determine whether the received device identifier provided by the other computing device corresponds sufficiently to a known device identifier. Additionally or alternatively, the first computing device may transmit the request to authenticate the second computing device to the authentication system. The authentication system may then request a new device identifier from the second computing device and compare the device identifier received from the second computing device to known device identifiers, optionally limited to known device identifiers associated with the second computing device.

Similarly, to verify the connection between a computing device and the authentication system, the computing device may request authentication of the authentication system and/or the authentication system may request authentication of the computing device. For example, the computing device may request that the authentication system authenticate itself, and may include a device identifier from the computing device with the request. In response to the authentication request, the authentication system may then measure and/or determine physical and/or device parameters to generate a new device identifier, and/or may retrieve a stored device identifier, before transmitting the new and/or stored device identifier. If the request did not include a device identifier from the computing device, the authentication system may transmit a request for a device identifier from the computing device. One or both of the computing device and the authentication system may then determine whether the received device identifier provided by the computing device and/or authentication system corresponds sufficiently to a known device identifier.

Authentication requests may be generated in advance of a data-sharing event or other device-to-device or device-to-authentication system communication task. Additionally or alternatively, authentication requests may be generated at a predetermined or dynamically determined frequency, particularly while a secure communication channel between computing devices and/or between a computing device and an authentication system remains open. For example, authentication requests may be generated periodically at least every 30 minutes, at least every hour, at least every 3 hours, at least every 6 hours, at least every 12 hours, at least every 18 hours, at least every day, at least every 2 days, at least every 3 days, at least every week, at least every 2 weeks, at least every 3 weeks, at least every month, at least every 2 months, at least every 3 months, at least every 6 months, at most every 6 months, at most every 3 months, at most every 2 months, at most every month, at most every 3 weeks, at most every 2 weeks, at most every week, at most every 3 days, at most every 2 days, at most every day, at most every 18 hours, at most every 12 hours, at most every 6 hours, at most every 3 hours, at most every hour, and/or at most every 30 minutes. The frequency with which authentication requests may be generated may depend on, for example, security policies, network conditions, computational resource availability, sensitivity of the data being transferred, and/or the level of risk associated with unauthorized access to a computing device involved in the data transfer. In this way, authentication requests may be generated, and/or updated device identifiers may be transmitted, based on the time at which the most recent authentication request was generated and/or the most recent updated device identifier was transmitted.

Additionally or alternatively, authentication requests may be generated based on the number of interactions and/or data exchanges with a particular other computing device. For example, authentication requests may be generated at least every time, at least every other time, at least every two times, at least every three times, at least every five times, at least every 10 times, at least every 20 times, at most every 20 times, at most every 10 times, at most every five times, at most every three times, at most every two times, at most every two times, and/or at most every time a request for an interaction and/or data exchange is received from a particular other computing device and/or generated for the particular other computing device. Frequency of authentication may be higher when interacting with a new computing device on a network, for example following transfer of known device identifiers for the new computing device to a database on an authentication system and/or on a computing device for the first time. In this case, an exemplary computing device may generate an authentication request every time it interacts and/or exchanges data with the new computing device.

Additionally or alternatively, authentication requests may be generated in response to one or more detected events including a computing device powering on or restarting, a change in network connectivity, a detected security anomaly, an attempt to access restricted data, a scheduled system check, a firmware and/or software update, and/or a request from an external system or administrator for reauthentication. These authentication requests may trigger additional security procedures, for example transmission of a follow-up request for remeasurement of physical parameters and/or regeneration of a device identifier, and/or provision of a different stored device identifier, if anomalies are detected in the correspondence analysis of the initially provided device identifier with one or more known device identifiers.

Authentication requests described above, including between the first computing device and second computing device, between the first computing device and authentication system, and/or between the second computing device and the authentication system may include a request for data transfer involving the respective devices and/or systems. For example, the authentication request may include a request for data transfer involving the first computing device and second computing device, the first computing device and authentication system, and/or the second computing device and the authentication system.

Because physical parameter values may fluctuate, a similarity score may be computed to determine whether the received device identifier is sufficiently close to a known device identifier while allowing for minor deviations. To facilitate this determination, at sub-step 344, an exemplary system may compute a similarity score for the first computing device based on a plurality of stored device identifiers associated with the first computing device. Likewise, at sub-step 346, a similarity score may be computed for the second computing device based on a plurality of stored device identifiers associated with the second computing device.

The similarity score may be computed using distance metrics and/or statistical correlation functions to determine whether a newly received device identifier corresponds to a known device identifier, allowing for minor variations while maintaining security. Similarity score techniques based on distance metrics may include computing Euclidean distance, cosine similarity, and/or Hamming distance to quantify how different the newly received device identifier is from one or more known device identifiers. For example, a device identifier derived from temperature fluctuations or voltage readings may be compared by calculating the distance between the newly received device identifier and one or more known device identifiers using a predefined threshold. If the calculated distance falls within the predefined threshold, indicating only minor variations, authentication may be approved.

For hashed or binary device identifiers, similarity scores can be computed using bit-level distance metrics as an additional or alternative approach to numerical comparisons of physical parameter values. Hamming distance may be used to count the number of differing bits in two hashed identifiers, allowing authentication if variations fall within an acceptable threshold. For binary-encoded device identifiers, similarity may additionally or alternatively be evaluated using Jaccard similarity, which may measure the proportion of matching bits between two device identifiers.

Similarity score techniques based on statistical correlation functions, such as Pearson correlation, may compare patterns over time rather than exact device identifier values. This may be useful for device identifiers based on physical parameter variations, such as voltage fluctuations or processor load cycles, ensuring that minor variations do not cause authentication failures. Additionally, machine learning techniques, such as those based on the k-nearest neighbors algorithm and/or support vector machines, may classify newly received device identifiers based on their proximity to known or previously authenticated device identifiers. This may allow an exemplary system to recognize legitimate variations while rejecting unauthorized devices attempting to spoof known device identifiers.

Depending on whether the received device identifiers correspond to known device identifiers, an exemplary system may initiate one or more authentication responses. At step 350, if both the first and second device identifiers are determined to correspond to known, authorized device identifiers, an exemplary system may allow secure data transfer between the computing devices. For example, if the first device identifier corresponds to a known first device identifier and the second device identifier corresponds to a known second device identifier, data transfer may be allowed. Such an authentication process may allow the computing devices to communicate without use of pre-shared keys or manually exchanged credentials. This step may ensure that only verified computing devices may engage in data exchange, thereby preventing unauthorized access.

An exemplary system may enforce a time limit on the data exchange, after which one or both computing devices may need to be reauthenticated to maintain security and ensure the integrity of ongoing communication. This reauthentication process may involve repeating the steps described above, including re-sensing physical parameters, regenerating device identifiers, and determining whether device identifiers correspond to known identifiers. Implementing a time limit may help mitigate risks associated with session hijacking, ensuring that only continuously verified computing devices can maintain data transfer. The reauthentication interval may be predefined based on security policies and/or operational requirements, and may balance security with computing device performance. One or both computing devices exchanging data may provide a signal to notify the other computing device and/or an external authentication system that authorized communications have been completed, allowing the computing devices to cease authentication activities.

If either computing device fails authentication, at step 352, an exemplary system may restrict data transfer between the two computing devices. This may occur if either the first device identifier, the second device identifier, or both do not sufficiently correspond to a known device identifier, indicating that one or both of the computing devices may be unauthorized, compromised, and/or spoofed. For example, if the first device identifier does not correspond to a known first device identifier and/or the second device identifier does not correspond to a known second device identifier, data transfer between the two computing devices may be restricted.

In addition to restricting data transfer between the two computing devices, an exemplary system may initiate alternative security actions, such as logging the failed authentication attempt and/or notifying a system administrator. In some implementations, the authentication system may generate a remote software override that allows an external system to shut down a computing device suspected of being accessed by unauthorized communications. This override may be triggered in response to multiple failed authentication attempts and/or detection of unusual device identifier variations.

Once a computing device has been remotely shut down, it may be reauthenticated. As part of this process, new device identifiers associated with the computing device may be generated, and the authentication system may be updated to reflect these changes. The authentication system may then receive a device identifier from the computing device for comparison to the updated device identifiers before allowing the computing device to rejoin the network and resume normal operations. This approach may ensure that compromised or unauthorized devices cannot resume data transfer without reauthentication.

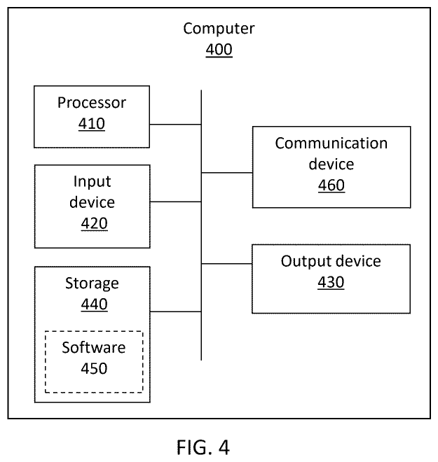

In one or more examples, the disclosed systems and methods utilize or may include a computer system. FIG. 4 depicts an exemplary computing system according to one or more examples of the disclosure. Computer 400 can be a host computer connected to a network. Computer 400 can be a client computer or a server. As shown in FIG. 4, computer 400 can be any suitable type of microprocessor-based device, such as a personal computer, workstation, server, or handheld computing device, such as a phone or tablet. The computer can include, for example, one or more of processor 410, input device 420, output device 430, storage 440, and communication device 460. Input device 420 and output device 430 can correspond to those described above and can either be connectable or integrated with the computer.

Input device 420 can be any suitable device that provides input, such as a touch screen or monitor, keyboard, mouse, or voice-recognition device. Output device 430 can be any suitable device that provides an output, such as a touch screen, monitor, printer, disk drive, or speaker.

Storage 440 can be any suitable device that provides storage, such as an electrical, magnetic, or optical memory, including a random-access memory (RAM), cache, hard drive, CD-ROM drive, tape drive, or removable storage disk. Communication device 460 can include any suitable device capable of transmitting and receiving signals over a network, such as a network interface chip or card. The components of the computer can be connected in any suitable manner, such as via a physical bus or wirelessly. Storage 440 can be a non-transitory computer-readable storage medium comprising one or more programs, which, when executed by one or more processors, such as processor 410, cause the one or more processors to execute methods described herein.

Software 450, which can be stored in storage 440 and executed by processor 410, can include, for example, the programming that embodies the functionality of the present disclosure (e.g., as embodied in the systems, computers, servers, and/or devices as described above). In one or more examples, software 450 can include a combination of servers such as application servers and database servers.

Software 450 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 440, that can contain or store programming for use by or in connection with an instruction execution system, apparatus, or device.

Software 450 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 400 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 400 can implement any operating system suitable for operating on the network. Software 450 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A method of securely transferring data between a first computing device and a second computing device, the method comprising:
sensing one or more first physical parameters associated with the first computing device using a first physical sensor on the first computing device;
generating a first device identifier based on the one or more first physical parameters;
sensing one or more second physical parameters associated with the second computing device using a second physical sensor on the second computing device;
generating a second device identifier based on the one or more second physical parameters; and
allowing the transfer of data between the first computing device and the second computing device if the first device identifier corresponds to a known first device identifier and the second device identifier corresponds to a known second device identifier.

2. The method of claim 1, wherein the one or more first physical parameters and the one or more second physical parameters each comprise at least one parameter selected from a group consisting of: a sensor acceleration profile, a sensor orientation profile, a magnetic field signature, a temperature measurement, an acoustic noise profile, a voltage profile, a current profile, a clock drift profile, geographical positioning data, a processor load signature, an ambient pressure measurement, an ambient humidity measurement, and an ambient light measurement.

3. The method of claim 1, wherein generating the first device identifier and the second device identifier comprises:
applying a first transformation function to encode the one or more first physical parameters to form the first device identifier; and
applying a second transformation function to encode the one or more second physical parameters to form the second device identifier.

4. The method of claim 3, wherein the first transformation function and the second transformation function each comprise a cryptographic hashing function configured to generate a device identifier based on the respective one or more physical parameters.

5. The method of claim 3, wherein the first transformation function and the second transformation function are each configured to generate a device identifier based on variations in the respective one or more physical parameters.

6. The method of claim 3, wherein the method further comprises:
aggregating a plurality of values corresponding to the respective one or more physical parameters to generate one or more composite values; and
applying the respective transformation function to encode the generated one or more composite values to form a device identifier.

7. The method of claim 1, wherein:
generating the first device identifier is based on the one or more first physical parameters and one or more first device parameters associated with the first computing device; and
generating the second device identifier is based on the one or more second physical parameters and one or more second device parameters associated with the second computing device.

8. The method of claim 7, wherein the one or more first device parameters and the one or more second device parameters each comprise at least one parameter selected from a group consisting of: an initial power-up timestamp, a device serial number, and a network identifier.

9. The method of claim 8, wherein generating the first device identifier and the second device identifier comprises:
applying a first transformation function to encode the one or more first physical parameters and the one or more first device parameters to form the first device identifier; and
applying a second transformation function to encode the one or more second physical parameters and the one or more second device parameters to form the second device identifier.

10. The method of claim 9, wherein the first transformation function and the second transformation function each comprise a cryptographic hashing function configured to generate a device identifier based on the respective one or more physical parameters and the respective one or more device parameters.

11. The method of claim 9, wherein the method further comprises:
aggregating a plurality of values corresponding to the respective one or more physical parameters and the respective one or more device parameters to generate one or more composite values; and
applying the respective transformation function to encode the generated one or more composite values to form a device identifier.

12. The method of claim 1, wherein the method comprises:
transmitting the first device identifier to the second computing device;
determining, at the second computing device, if the first device identifier corresponds to the known first device identifier;
transmitting the second device identifier to the first computing device; and
determining, at the first computing device, if the second device identifier corresponds to the known second device identifier.

13. The method of claim 12, wherein the method comprises, prior to transmitting the first device identifier to the second computing device, transmitting from the second computing device to the first computing device a request for the first device identifier.

14. The method of claim 12, wherein the method comprises, prior to transmitting the second device identifier to the first computing device, transmitting from the first computing device to the second computing device a request for the second device identifier.

15. The method of claim 1, wherein the method comprises:
transmitting, to an authentication system, the first device identifier and the second device identifier; and
determining, at the authentication system, if the first device identifier corresponds to the known first device identifier and the second device identifier corresponds to the known second device identifier.

16. The method of claim 15, wherein the method comprises, prior to transmitting, to an authentication system, the first device identifier and the second device identifier:
transmitting, to the authentication system, a request for a data transfer involving the first computing device and the second computing device,
wherein the request is transmitted from the first computing device, the second computing device, or both computing devices.

17. The method of claim 15, wherein the method comprises, prior to transmitting, to an authentication system, the first device identifier and the second device identifier:
transmitting, from the authentication system, a request for a data transfer involving the first computing device and the second computing device,
wherein the request is transmitted to the first computing device, the second computing device, or both computing devices.

18. The method of claim 15, wherein the method comprises
sensing one or more third physical parameters associated with the authentication system using a third physical sensor on the authentication system;
generating a third device identifier based on the one or more third physical parameters;
allowing the transfer, between the first computing device and the authentication system and between the second computing device and the authentication system, of respective device identifiers if the first device identifier corresponds to the known first device identifier, the second device identifier corresponds to the known second device identifier, and the third device identifier corresponds to a known third device identifier.

19. The method of claim 15, wherein the method comprises:
storing, on the first computing device, one or more device identifiers generated based on the one or more first physical parameters;
transmitting one of the one or more stored device identifiers generated based on the one or more first physical parameters to the second computing device, the authentication system, or both;
storing, on the second computing device, one or more device identifiers generated based on the one or more second physical parameters; and
transmitting one of the one or more stored device identifiers generated based on the one or more second physical parameters to the first computing device, the authentication system, or both.

20. The method of claim 15, wherein the method comprises storing, on at least one of the first computing device, the second computing device, or the authentication system, one or more parameters, wherein the one or more parameters comprise at least one parameter selected from a group comprising:
the first device identifier;
the second device identifier;
one or more timestamps corresponding to the transmission of the first device identifier, the transmission of the second device identifier, or both; and
an indication of whether data transfer was allowed between the first computing device and the second computing device.

21. The method of claim 15, wherein the method comprises storing, on at least one of the first computing device, the second computing device, or the authentication system, one or more known device identifiers for comparison to the first device identifier, the second device identifier, or both.

22. The method of claim 15, wherein the method comprises:
transmitting, to at least one of the second computing device or the authentication system, an updated first device identifier after a first predetermined time period; and
transmitting to at least one of the first computing device or the authentication system an updated second device identifier after a second predetermined time period,
wherein the updated first device identifier and the updated second device identifier are based, respectively, on updated one or more first physical parameters and updated one or more second physical parameters.

23. The method of claim 22, wherein the first predetermined time period, the second predetermined time period, or both, are determined based on a time at which the first device identifier was transmitted, a time at which the second device identifier was transmitted, or both.

24. The method of claim 1, wherein the known first device identifier and the known second device identifier each correspond to a device authorized to participate in data transfer.

25. The method of claim 1, wherein the method comprises computing a first similarity score and a second similarity score based respectively on a plurality of device identifiers associated with the first computing device and the second computing device to determine if the first device identifier corresponds to the known first device identifier and the second device identifier corresponds to the known second device identifier.

26. The method of claim 1, wherein the method comprises restricting data transfer between the first computing device and the second computing device if the first device identifier does not correspond to a known first device identifier or the second device identifier does not correspond to a known second device identifier.

27. A system for securely transferring data between a first computing device and a second computing device, the system comprising one or more processors and memory storing instructions that, when executed by the one or more processors, cause the system to:
sense one or more first physical parameters associated with the first computing device using a first physical sensor on the first computing device;
generate a first device identifier based on the one or more first physical parameters;
sense one or more second physical parameters associated with the second computing device using a second physical sensor on the second computing device;
generate a second device identifier based on the one or more second physical parameters; and
allow the transfer of data between the first computing device and the second computing device if the first device identifier corresponds to a known first device identifier and the second device identifier corresponds to a known second device identifier.

28. A non-transitory computer readable storage medium storing instructions for securely transferring data between a first computing device and a second computing device, wherein the instructions, when executed by one or more processors of an electronic device, cause the device to:
sense one or more first physical parameters associated with the first computing device using a first physical sensor on the first computing device;
generate a first device identifier based on the one or more first physical parameters;
sense one or more second physical parameters associated with the second computing device using a second physical sensor on the second computing device;
generate a second device identifier based on the one or more second physical parameters; and
allow the transfer of data between the first computing device and the second computing device if the first device identifier corresponds to a known first device identifier and the second device identifier corresponds to a known second device identifier.
